(19) United States
(12) Patent Application Publication
(10) Pub. No.: US 2019/0225805 A1
(43) Pub. Date: Jul. 25, 2019

(54) RUBBER-PARTICLE-DISPERSED POLYIMIDE RESIN SOLUTION AND RUBBER-PARTICLE-DISPERSED POLYIMIDE SHEET

(71) Applicant: FUJI XEROX CO., LTD., Tokyo (JP)

(72) Inventors: Tomoya SASAKI, Kanagawa (JP); Hidekazu HIROSE, Kanagawa (JP); Katsumi NUKADA, Kanagawa (JP); Kosaku YOSHIMURA, Kanagawa (JP); Akira IMAI, Kanagawa (JP); Hajime SUGAHARA, Kanagawa (JP)

(73) Assignee: FUJI XEROX CO., LTD., Tokyo (JP)

(21) Appl. No.: 16/141,993

(22) Filed: Sep. 26, 2018

(30) Foreign Application Priority Data
Jan. 23, 2018 (JP) 2018-009032

(51) Int. Cl. C08L 79/08; C08J 5/18

(52) U.S. Cl. CPC C08L 79/08; C08J 5/18; C08L 2201/54; C08J 2409/06; C08J 2409/02; C08J 2379/08

(57) ABSTRACT

A rubber-particle-dispersed polyimide resin solution contains at least one resin selected from the group consisting of polyimide precursors and polyimides having a solubility of 1% by mass or more in an aprotic polar solvent; rubber particles; and a solvent including a poor solvent for the rubber particles.

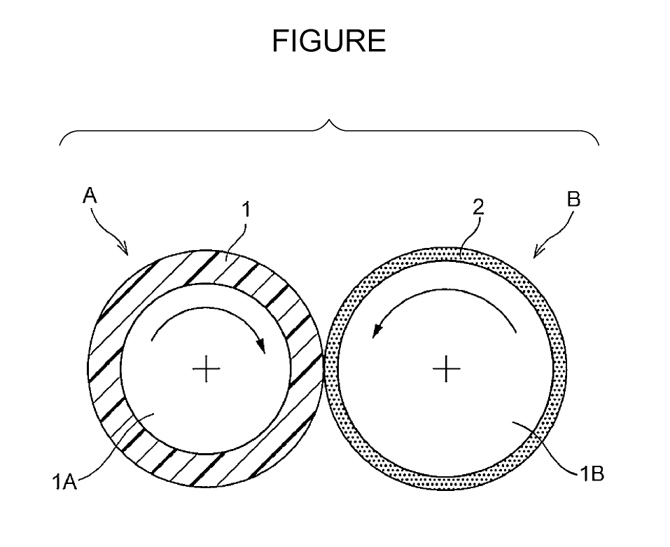

### CROSS-REFERENCE TO RELATED APPLICATIONS

This application is based on and claims priority under 35 USC 119 from Japanese Patent Application No. 2018-009032 filed Jan. 23, 2018.

### BACKGROUND

### (i) Technical Field

The present disclosure relates to rubber-particle-dispersed polyimide resin solutions and rubber-particle-dispersed polyimide sheets.

### (ii) Related Art

Polyimide sheets are characterized by high elasticity and break strength; however, they tend to be damaged when subjected to physical stresses periodically or for an extended period of time because of their low ability to relieve stresses. Polyimide sheets also exhibit low conformity and adhesion to various shapes. Accordingly, attempts have been made to form polyimide sheets having mixed therein rubber materials that have rubber elasticity, that are capable of conforming to various shapes, and that exhibit high shock absorbency to achieve high strength, high shock absorption, and high adhesion.

For example, Japanese Laid Open Patent Application Publication No. 2001-254022 discloses the manufacture of a belt from a thermoplastic resin, such as polyimide, in which partially conductive rubber particles are dispersed by melt kneading.

Japanese Laid Open Patent Application Publication No. 2006-084721 discloses the manufacture of an endless belt including a friction layer formed from a polyimide or polyamide-imide resin solution having rubber particles dispersed therein.

Japanese Laid Open Patent Application Publication No. 2009-086087 discloses the manufacture of an endless belt from a polyamide-imide or polyimide precursor solution having non-silicone-based rubber particles dispersed therein.

Polyimide sheets containing rubber particles in the related art are susceptible to surface scratches since the rubber particles in the polyimide sheets tend to be deformed, aggregated, coalesced, or decomposed.

### SUMMARY

Aspects of non-limiting embodiments of the present disclosure relate to a rubber-particle-dispersed polyimide resin solution that forms a rubber-particle-dispersed polyimide sheet with reduced susceptibility to surface scratches as compared to a polyimide resin solution containing only rubber particles, a polyimide precursor, and an aprotic polar solvent.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a rubber-particle-dispersed polyimide resin solution comprising at least one resin selected from the group consisting of polyimide precursors and polyimides having a solubility of 1% by mass or more in an aprotic polar solvent; rubber particles; and a solvent comprising a poor solvent for the rubber particles.

### BRIEF DESCRIPTION OF THE DRAWINGS

An exemplary embodiment of the present disclosure will be described in detail based on the following FIGURE, wherein:

the FIGURE is a schematic view illustrating a durability test on rubber-particle-dispersed polyimide sheets.

### DETAILED DESCRIPTION

An exemplary embodiment will hereinafter be described as an example of the present disclosure.

### Rubber-Particle-Dispersed Polyimide Resin Solution

A rubber-particle-dispersed polyimide resin solution according to the exemplary embodiment comprises at least one resin selected from the group consisting of polyimide precursors and polyimides having a solubility of 1% by mass or more in an aprotic polar solvent (which may be hereinafter referred to as “soluble polyimide”); rubber particles; and a solvent comprising a poor solvent for the rubber particles.

In the exemplary embodiment, “polyimides having a solubility of 1% by mass or more in an aprotic polar solvent” means so-called soluble polyimides; this term represents soluble polyimides in terms of solubility in an aprotic polar solvent.

“A solubility of 1% by mass or more in an aprotic polar solvent” refers to a solubility of 1% by mass or more in an aprotic polar solvent at 25° C. The soluble polyimides preferably have a solubility of 5% by mass or more, more preferably 10% by mass or more, in an aprotic polar solvent as represented in terms of solubility in an aprotic polar solvent at 25° C.

### Polyimide Precursor

A polyimide precursor is obtained by the polymerization of a tetracarboxylic dianhydride and a diamine compound. Specifically, a polyimide precursor is a resin (polyamic acid) containing repeating units represented by general formula (I).

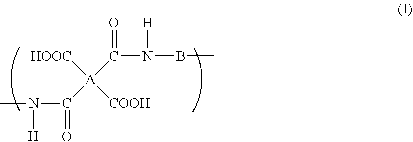

In general formula (I), A represents a tetravalent organic group, and B represents a divalent organic group.

The tetravalent organic group for A in general formula (I) is a residue of a tetracarboxylic dianhydride used as a starting material, with the four carboxyl groups excluded therefrom.

The divalent organic group for B is a residue of a diamine compound used as a starting material, with the two amino groups excluded therefrom.

That is, a polyimide precursor containing repeating units represented by general formula (I) is a polymer of a tetracarboxylic dianhydride and a diamine compound.

The tetracarboxylic dianhydride may be either an aromatic compound or an aliphatic compound, preferably an aromatic compound. That is, the tetravalent organic group for A in general formula (I) is preferably an aromatic organic group.

Examples of aromatic tetracarboxylic dianhydrides include pyromellitic dianhydride, 3,3′,4,4′-benzophenonetetracarboxylic dianhydride, 3,3′,4,4′-biphenyl sulfone tetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, 2,3,3′,4′-biphenyltetracarboxylic dianhydride, bis(phthalic acid) phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenyl ether dianhydride, and bis(triphenylphthalic acid)-4,4′-diphenylmethane dianhydride.

Examples of aliphatic tetracarboxylic dianhydrides include aliphatic and alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofuryl)-3-methyl-3-cyclohexene-1,2-dicarboxylic dianhydride, and bicyclo[2,2,2]-oct-7-ene-2,3,5,6-tetracarboxylic dianhydride; and aromatic-ring-containing aliphatic tetracarboxylic dianhydrides such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Preferred among these tetracarboxylic dianhydrides are aromatic tetracarboxylic dianhydrides, specific examples thereof including pyromellitic dianhydride, 3,3′,4,4′-biphenyltetracarboxylic dianhydride, 2,3,3′,4′-biphenyltetracarboxylic dianhydride, 3,3′,4,4′-biphenyl ether tetracarboxylic dianhydride, and 3,3′,4,4′-benzophenonetetracarboxylic dianhydride, more preferably pyromellitic dianhydride, 3,3′,4,4′-biphenyltetracarboxylic dianhydride, and 3,3′,4,4′-benzophenonetetracarboxylic dianhydride, particularly preferably 3,3′,4,4′-biphenyltetracarboxylic dianhydride.

These tetracarboxylic dianhydrides may be used alone or in combination of two or more.

If a combination of two or more tetracarboxylic dianhydrides is used, a combination of aromatic tetracarboxylic dianhydrides, a combination of aliphatic tetracarboxylic dianhydrides, or a combination of aromatic and aliphatic tetracarboxylic dianhydrides may be used.

The diamine compound is a diamine compound having two amino groups in the molecular structure thereof. The diamine compound may be either an aromatic compound or an aliphatic compound, preferably an aromatic compound. That is, the divalent organic group for B in general formula (I) is preferably an aromatic organic group.

Examples of diamine compounds include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bound to an aromatic ring and a heteroatom other than the nitrogen atoms of the amino groups, such as diaminotetraphenylthiophene; and aliphatic and alicyclic diamines such as 1,1-m-xylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylenedimethylenediamine, tricyclo[6,2,1,0^{2.7}]-undecylenedimethyldiamine, and 4,4′-methylenebis(cyclohexylamine).

Preferred among these diamine compounds are aromatic diamine compounds, specific examples thereof including p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenyl sulfone, particularly preferably 4,4′-diaminodiphenyl ether and p-phenylenediamine.

These diamine compounds may be used alone or in combination of two or more. If a combination of two or more diamine compounds is used, a combination of aromatic diamine compounds, a combination of aliphatic diamine compounds, or a combination of aromatic and aliphatic diamine compounds may be used.

In some cases, two or more tetracarboxylic dianhydrides and/or diamine compounds may be used for copolymerization to control the ease of handling and mechanical properties of the resulting rubber-particle-dispersed polyimide sheet.

Examples of combinations for copolymerization include the copolymerization of tetracarboxylic dianhydrides and/or diamine compounds having one aromatic ring in the chemical structure thereof with tetracarboxylic dianhydrides and/or diamine compounds having two or more aromatic rings in the chemical structure thereof; and the copolymerization of aromatic tetracarboxylic dianhydrides and/or diamine compounds with carboxylic dianhydrides and/or diamine compounds containing flexible linking groups such as alkylene, alkyleneoxy, and siloxane groups.

The polyimide precursor preferably has a number average molecular weight of from 1,000 to 150,000, more preferably from 5,000 to 130,000, even more preferably from 10,000 to 100,000.

If the number average molecular weight of the polyimide precursor falls within the above ranges, the polyimide precursor may exhibit less decrease in solubility in solvents and therefore better film-forming properties.

The number average molecular weight of the polyimide precursor is measured by a gel permeation chromatography (GPC) technique under the following measurement conditions:
Column: Tosoh TSKgel α-M (7.8 mm I.D.×30 cm)
Eluent: dimethylformamide (DMF)/30 mM LiBr/60 mM phosphoric acid
Flow rate: 0.6 mL/min
Injection volume: 60 μL
Detector: differential refractive index detector (RI)

The amount (concentration) of the polyimide precursor is preferably from 0.1% by mass to 40% by mass, more preferably from 0.5% by mass to 25% by mass, even more preferably from 1% by mass to 20% by mass, based on the total mass of the polyimide precursor solution.

### Soluble Polyimide

Any soluble polyimide that exhibits the solubility described above may be used, including known soluble polyimides. A soluble polyimide is obtained by a polymerization reaction of substantially equimolar amounts of tetracarboxylic dianhydride and diamine components used as starting materials. Specifically, a soluble polyimide is obtained by polymerization using the necessary amount of monomer for introducing a flexible bent structure into the main chain. A soluble polyimide is also obtained using a monomer containing a functional group that improves the solubility in organic solvents, such as an alkyl or trifluoromethyl group.

Examples of commercially available soluble polyimides include SOLPIT 6,6-PI manufactured by Solpit Industries, Ltd.; the Q-VR and Q-AD series manufactured by PI R&D Co., Ltd.; XENOMAX manufactured by Toyobo Co., Ltd.; the SPIXAREA series manufactured by Somar Corporation; and the NEOPULIM series manufactured by Mitsubishi Gas Chemical Company, Inc.

### Rubber Particles

The rubber particles in the exemplary embodiment are particles formed from a resin that exhibits rubber elasticity at room temperature.

The resin may have a linear, comb-shaped (grafted), or branched (star-shaped) main chain structure, provided that the resin exhibits rubber elasticity at room temperature. The resin may also have a structure partially crosslinked by a crosslinking monomer.

Any type of rubber particle may be used, including known rubber particles. Examples of rubber particles include particles of diene-based rubber (rubber having a diene polymer structure in the molecule thereof) such as natural rubber (NR), isoprene rubber (IR), acrylonitrile-butadiene-based rubber (rubber having an acrylonitrile-butadiene copolymer structure in the molecule thereof) such as acrylonitrile-butadiene rubber (NBR), and styrene-butadiene-rubber-based rubber (rubber having a styrene-butadiene copolymer structure in the molecule thereof) such as styrene-butadiene rubber (SBR); hydrogenated derivatives of the diene-based rubber; ethylene-propylene rubber (ethylene-propylene rubber bipolymer (EPM) and ethylene-propylene-rubber-containing terpolymer (EPDM)); butyl rubber (IIR); copolymers of isobutylene with aromatic vinyl- or diene-based monomers; acrylic rubber (ACM); ionomers; brominated butyl rubber (Br-IIR); chlorinated butyl rubber (Cl-IIR); brominated isobutylene-p-methylstyrene copolymer (BIMS); chloroprene rubber (CR); hydrin rubber (CHR); chlorosulfonated polyethylene (CSM); chlorinated polyethylene (CM); polysulfide rubber; fluorocarbon rubber; and silicone-based rubber (rubber having a silicone structure in the molecule thereof) such as (fluoro)silicone rubber. Particles of acrylic-acid-modified derivatives, maleic-acid-modified derivatives, and carboxy-modified derivatives of these rubbers may also be used, provided that they have structures derived from these rubbers. These types of rubber particles may be used alone or in combination of two or more.

Among these types of rubber particles, those comprising diene-based rubber and silicone-based rubber are preferred to achieve reduced susceptibility to surface scratches. More preferred are rubber particles comprising at least one rubber selected from the group consisting of styrene-butadiene-based rubber, acrylonitrile-butadiene-based rubber, and silicone-based rubber. Even more preferred are rubber particles comprising at least one rubber selected from styrene-butadiene-based rubber and acrylonitrile-butadiene-based rubber.

To obtain a rubber-particle-dispersed polyimide sheet with reduced susceptibility to surface scratches, it is preferred that the rubber particles have a volume average particle size of from 0.05 μm to 2 μm, more preferably from 0.07 μm to 1.5 μm, even more preferably from 0.09 μm to 1 μm.

The volume average particle size of the rubber particles in the rubber-particle-dispersed polyimide resin solution according to the exemplary embodiment is measured as follows. The sample solution is diluted, and the particle size distribution of the rubber particles in the solution is measured with a COULTER COUNTER LS13 (manufactured by Beckman Coulter, Inc.). The measured particle size distribution is divided into particle size ranges (channels), and a cumulative volume distribution is plotted against the particle size ranges from smaller to larger sizes. The volume average particle size D50v is determined as the particle size at which the cumulative volume is 50% on the cumulative volume distribution plotted from smaller to larger sizes.

If it is difficult to measure the volume average particle size of the particles in the particle-dispersed polyimide resin solution according to the exemplary embodiment by the technique described above, the volume average particle size may be measured by other techniques such as dynamic light scattering techniques.

To obtain a rubber-particle-dispersed polyimide sheet with reduced susceptibility to surface scratches, it is preferred that the amount of the rubber particles be from 5% by mass to 50% by mass, more preferably from 10% by mass to 47% by mass, even more preferably from 15% by mass to 45% by mass, based on the solid content of the rubber-particle-dispersed polyimide resin solution.

### Poor Solvent for Rubber Particles

Examples of poor solvents for the rubber particles include organic solvents and water.

### Organic Solvent Serving as Poor Solvent for Rubber Particles

The use of an organic solvent as the poor solvent for the rubber particles will be described first.

In the exemplary embodiment, “poor solvent for the rubber particles” (which may be hereinafter simply referred to as “poor solvent”) refers to a solvent in which, when a liquid containing the rubber particles and the solvent is prepared such that the solid concentration of the rubber particles is 5%, 95% by mass or more of the rubber particles remain undissolved at 25° C. based on the total solid content of the rubber particles.

Specific examples of organic solvents serving as poor solvents include aliphatic-hydrocarbon-based solvent (solvent having an aliphatic hydrocarbon in one molecule), aliphatic-alcohol-based solvent (solvent having an alcohol in one molecule), glycol-based solvent (solvent having a glycol in one molecule), glycol-monoether-based solvent (solvent having a glycol monoether in one molecule), glycol-diether-based solvent (solvent having a glycol diether in one molecule (glyme-based solvent)), and glycerol-based solvent (solvent having a glycerol in one molecule).

Examples of aliphatic-hydrocarbon-based solvent include those containing from 9 to 15 carbon atoms.

Examples of aliphatic-alcohol-based solvent include those containing 15 or less carbon atoms.

Examples of glycol-based solvent include ethylene glycol, propylene glycol, diethylene glycol, and triethylene glycol.

Examples of glycol-monoether-based solvent include ethylene glycol monomethyl ether, ethylene glycol monoethyl ether, diethylene glycol monomethyl ether, and triethylene glycol monomethyl ether.

Examples of glycol-diether-based solvent (glyme-based solvent) include monoglyme, ethyl glyme (ethylene glycol diethyl ether), diglyme, ethyl diglyme (diethylene glycol diethyl ether), triglyme, and tetraglyme.

Among these poor solvents, glycol-based solvent, glycol-monoether-based solvent, and glycol-diether-based solvent (glyme-based solvent) are preferred to obtain a rubber-particle-dispersed polyimide sheet with reduced susceptibility to surface scratches.

To obtain a rubber-particle-dispersed polyimide sheet with reduced susceptibility to surface scratches, it is preferred that the poor solvent have a boiling point of from 150° C. to 250° C., more preferably from 180° C. to 230° C.

Among such poor solvents, diglyme (162° C.), diethylene glycol monomethyl ether (193° C.), ethylene glycol (197° C.), triglyme (216° C.), tripropylene glycol monomethyl ether (242° C.), diethylene glycol (244° C.), and triethylene glycol monomethyl ether (249° C.) are preferred to obtain a rubber-particle-dispersed polyimide sheet with reduced susceptibility to surface scratches. More preferred poor solvents are diethylene glycol monomethyl ether (193° C.), ethylene glycol (197° C.), triglyme (216° C.), and triethylene glycol monomethyl ether (249° C.). The numbers in parentheses refer to boiling points.

To obtain a rubber-particle-dispersed polyimide sheet with reduced susceptibility to surface scratches, the poor solvent may have a higher boiling point than an aprotic polar solvent, described later. The boiling point of the poor solvent is preferably 10° C. or more, more preferably 20° C. or more, even more preferably 40° C. or more, higher than that of the aprotic polar solvent.

These poor solvents may be used as a mixture with the aprotic polar solvent described later because of their low solvency for soluble polyimides and polyimide precursors. The amount of the organic solvent serving as the poor solvent is preferably from 30% by mass to 60% by mass, more preferably from 35% by mass to 55% by mass, based on the total mass of the solvent.

### Water Serving as Poor Solvent for Rubber Particles

Water may also be used as the poor solvent for the rubber particles. Examples of water include distilled water, deionized water, ultrafiltered water, and pure water. The amount of the water may be from 40% by mass to 100% by mass based on the total mass of the solvent. To further reduce the susceptibility of the rubber-particle-dispersed polyimide sheet to surface scratches, it is preferred that the lower limit of the water content be set to 50% by mass or more, more preferably 80% by mass or more. If the solvent is a mixture of water and an aprotic polar solvent, as described later, the upper limit of the water content may be set to 95% by mass or less to further reduce the susceptibility of the rubber-particle-dispersed polyimide sheet to surface scratches.

If water is used as the poor solvent, it may be used as an aqueous solvent containing water in combination with a water-soluble organic solvent selected from the above-mentioned organic solvents serving as poor solvents for the rubber particles. If the poor solvent is an aqueous solvent containing water, the amount of the water is preferably from 50% by mass to 100% by mass, more preferably from 70% by mass to 100% by mass, even more preferably from 80% by mass to 100% by mass, particularly preferably 100% by mass (water is used alone), based on the total mass of water and the water-soluble organic solvent (i.e., the total mass of the aqueous solvent containing water), provided that the amount of the water is 40% by mass or more (preferably 50% by mass or more) based on the total mass of the solvent. As used herein, “water-soluble” means that the substance of interest has a solubility of 1% by mass or more in water at 25° C.

Examples of water-soluble organic solvents include the water-soluble ether-based solvent, water-soluble ketone-based solvent, and water-soluble alcohol-based solvent given below.

Water-soluble ether-based solvent is a water-soluble solvent having an ether linkage in one molecule. Examples of water-soluble ether-based solvent include tetrahydrofuran (THF), dioxane, trioxane, 1,2-dimethoxyethane, diethylene glycol dimethyl ether, and diethylene glycol diethyl ether. Preferred among these examples of water-soluble ether-based solvent are tetrahydrofuran and dioxane.

Water-soluble ketone-based solvent is a water-soluble solvent having a ketone group in one molecule. Examples of water-soluble ketone-based solvent include acetone, methyl ethyl ketone, and cyclohexanone. Preferred among these examples of water-soluble ketone-based solvent is acetone.

Water-soluble alcohol-based solvent is a water-soluble solvent having an alcoholic hydroxyl group in one molecule. Examples of water-soluble alcohol-based solvent include methanol, ethanol, 1-propanol, 2-propanol, tert-butyl alcohol, ethylene glycol, ethylene glycol monoalkyl ether, propylene glycol, propylene glycol monoalkyl ether, diethylene glycol, diethylene glycol monoalkyl ether, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerol, 2-ethyl-2-hydroxymethyl-1,3-propanediol, and 1,2,6-hexanetriol. Preferred among these examples of water-soluble alcohol-based solvent are methanol, ethanol, 2-propanol, ethylene glycol, ethylene glycol monoalkyl ether, propylene glycol, propylene glycol monoalkyl ether, diethylene glycol, and diethylene glycol monoalkyl ether.

### Aprotic Polar Solvent

An aprotic polar solvent is used as a good solvent for soluble polyimides and polyimide precursors. In the exemplary embodiment, “good solvent” refers to a solvent in which a polyimide precursor exhibits a solubility of 5% by mass or more at 25° C.

Specific examples of aprotic polar solvents include N,N-dimethylformamide, N,N-dimethylacetamide, N-methylpyrrolidone, N-ethylpyrrolidone, tetramethylurea, 1,3-dimethyl-2-imidazolidinone, dimethylpropyleneurea, dimethyl sulfoxide, γ-butyrolactone, β-propiolactone, γ-valerolactone, δ-valerolactone, and γ-caprolactone.

Preferred among these aprotic polar solvents is at least one selected from the group consisting of N,N-dimethylacetamide (166° C.), tetramethylurea (177° C.), dimethyl sulfoxide (189° C.), γ-butyrolactone (204° C.), N-methylpyrrolidone (205° C.), and 1,3-dimethyl-2-imidazolidinone (220° C.), more preferably at least one selected from the group consisting of N,N-dimethylacetamide (166° C.), tetramethylurea (177° C.), dimethyl sulfoxide (189° C.), γ-butyrolactone (204° C.), and N-methylpyrrolidone (205° C.), even more preferably at least one of N,N-dimethylacetamide (166° C.), tetramethylurea (177° C.), and N-methylpyrrolidone (205° C.). The numbers in parentheses refer to boiling points.

If the solvent used in the rubber-particle-dispersed polyimide resin solution according to the exemplary embodiment is a mixture of an organic solvent serving as a poor solvent and an aprotic polar solvent, it is preferred that the amount of the aprotic polar solvent be from 90% by mass to 250% by mass based on the solid content of the rubber-particle-dispersed polyimide resin solution to obtain a rubber-particle-dispersed polyimide sheet with reduced susceptibility to surface scratches. From the same viewpoint, it is more preferred that the amount of the aprotic polar solvent be from 100% by mass to 200% by mass based on the solid content of the rubber-particle-dispersed polyimide resin solution.

If the solvent present in the rubber-particle-dispersed polyimide resin solution according to the exemplary embodiment is a mixture of water and an aprotic polar solvent, the amount of the aprotic polar solvent may be 250% by mass or less, or 100% by mass or less, based on the solid content of the rubber-particle-dispersed polyimide resin solution. To further reduce the susceptibility of the rubber-particle-dispersed polyimide sheet to surface scratches, it is preferred that the amount of the aprotic polar solvent be 50% by mass or less, more preferably 40% by mass or less, based on the solid content of the rubber-particle-dispersed polyimide resin solution. If a mixture of water and an aprotic polar solvent is used, the amount of the aprotic polar solvent may be more than 0% by mass, 1% by mass or more, 3% by mass or more, or 5% by mass or more, based on the solid content of the rubber-particle-dispersed polyimide resin solution.

### Imidization Catalyst

When the rubber-particle-dispersed polyimide resin solution according to the exemplary embodiment is used to form a rubber-particle-dispersed polyimide sheet, an imidization catalyst may be added to accelerate the imidization of the polyimide precursor at a temperature at which the rubber particles do not pyrolyze (i.e., 300° C. or lower). The imidization catalyst used to accelerate the imidization reaction may be any imidization catalyst. Examples of imidization catalysts include dehydrating agents such as acid anhydrides; condensing agents such as acetic anhydride and pyridine; phenol derivatives; sulfonic acid derivatives; acid catalysts such as benzoic acid derivatives; quaternary ammonium salts; and thermal base generators such as carbamate compounds, which are thermally decomposed to generate a base.

If water is used as the poor solvent and an organic amine compound, described later, is added, the organic amine compound itself functions as an imidization accelerator. Thus, if water is used as the poor solvent, the organic amine compound may serve as a suitable imidization catalyst.

If water is used as the poor solvent, the resin used in the rubber-particle-dispersed polyimide resin solution according to the exemplary embodiment may be a polyimide precursor, and the organic amine described later may be added. Water has a lower solvency for the rubber particles than organic solvents serving as poor solvents; therefore, the likelihood of the deformation, aggregation, and coalescence of the rubber particles in the rubber-particle-dispersed polyimide resin solution may be further reduced. The likelihood of the deformation, aggregation, and coalescence of the rubber particles may also be further reduced when a film is formed from the rubber-particle-dispersed polyimide resin solution.

If the rubber-particle-dispersed polyimide resin solution contains an organic amine compound, the organic amine compound may form an amine salt with the carboxyl groups in the polyimide precursor, which may make it water-soluble and thus eliminate the need for the aprotic polar solvent described above. Furthermore, since the organic amine may serve as an imidization catalyst, as described above, the organic amine may accelerate imidization at 300° C. or lower (e.g., around 250° C.).

Rubber particles are often commercially available in the form of an aqueous dispersion. Thus, if water is used as the poor solvent, water present in an aqueous dispersion of rubber particles may be directly used.

From these viewpoints, the rubber-particle-dispersed polyimide resin solution according to the exemplary embodiment may contain water as the poor solvent and a polyimide precursor as the resin and may further contain an organic amine.

### Organic Amine Compound

The organic amine compound is a compound that may convert the polyimide precursor (its carboxyl groups) into an amine salt to increase its solubility in aqueous solvents and may also function as an imidization accelerator. Specifically, the organic amine compound may be an amine compound having a molecular weight of 170 or less. The organic amine compound may be a compound other than the diamine compound used as a starting material for the polyimide precursor.

The organic amine compound may be a water-soluble compound. “Water-soluble” means that the substance of interest has a solubility of 1% by mass or more in water at 25° C.

Examples of organic amine compounds include primary amine compounds, secondary amine compounds, and tertiary amine compounds. Ammonia is not included in organic amine compounds in the exemplary embodiment.

Preferred among these organic amine compounds are secondary amine compounds and tertiary amine compounds, more preferably tertiary amine compounds.

If a primary or secondary amine compound, which has a hydrogen atom on its nitrogen atom, is used as the organic amine compound, some of the organic amine compound might react with the polyimide precursor or soluble polyimide and also with the rubber particles. This would decrease the storage stability of the rubber-particle-dispersed polyimide resin solution and the effect of reducing the susceptibility of the resulting rubber-particle-dispersed polyimide sheet to surface scratches.

In contrast, the use of a tertiary amine compound may avoid the reaction that might occur if a primary or secondary amine compound is used. In addition, the use of a tertiary amine compound may further increase the solubility of the polyimide precursor in solvents, thus further improving the film-forming properties, and may also further improve the storage stability of the polyimide precursor solution.

Examples of organic amine compounds include monoamine compounds and polyamine compounds, including diamine compounds.

Examples of primary amine compounds include methylamine, ethylamine, n-propylamine, isopropylamine, 2-ethanolamine, and 2-amino-2-methyl-1-propanol.

Examples of secondary amine compounds include dimethylamine, 2-(methylamino)ethanol, 2-(ethylamino)ethanol, and morpholine.

Examples of tertiary amine compounds include 2-dimethylaminoethanol, 2-diethylaminoethanol, 2-dimethylaminopropanol, pyridine, triethylamine, picoline, methylmorpholine, ethylmorpholine, 1,2-dimethylimidazole, and 2-ethyl-4-methylimidazole.

From the viewpoint of film-forming properties, the organic amine compound may also be an amine compound (particularly a tertiary amine compound) having a nitrogen-containing heterocyclic structure. Examples of amine compounds having a nitrogen-containing heterocyclic structure (hereinafter referred to as “nitrogen-containing heterocyclic amine compound”) include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, and polyamines.

Preferred from the viewpoint of film-forming properties is at least one nitrogen-containing heterocyclic amine compound selected from the group consisting of morpholines, pyridines, and imidazoles, more preferably at least one nitrogen-containing heterocyclic amine compound selected from the group consisting of N-methylmorpholine, pyridine, and picoline.

Preferred among these organic amine compounds are those having a boiling point of 60° C. or higher (more preferably from 60° C. to 200° C., even more preferably from 70° C. to 150° C.) If the organic amine compound has a boiling point of 60° C. or higher, less organic amine compound may volatilize from the polyimide precursor solution during storage. This may result in less decrease in the solubility of the polyimide precursor in solvents.

The amount of the organic amine compound is preferably from 120 mole percent to 200 mole percent, more preferably from 130 mole percent to 180 mole percent, even more preferably from 140 mole percent to 160 mole percent, based on the number of moles of carboxyl groups (—COOH) in the polyimide precursor in the polyimide precursor solution.

If the amount of the organic amine compound is within the above ranges, the organic amine compound may further increase the solubility of the polyimide precursor in solvents, thus further improving the film-forming properties, and may also further improve the storage stability of the polyimide precursor solution.

These organic amine compounds may be used alone or in combination of two or more.

### Other Additives

In a method for manufacturing the rubber-particle-dispersed polyimide resin solution according to the exemplary embodiment, the polyimide resin solution may contain other additives such as catalysts for accelerating the imidization reaction and leveling agents for improving the film quality.

Examples of catalysts that may be used for accelerating the imidization reaction include dehydrating agents such as acid anhydrides, phenol derivatives, sulfonic acid derivatives, and acid catalysts such as benzoic acid derivatives.

The polyimide resin solution may also contain a conductive material (conductive (e.g., having a volume resistivity of less than 10⁷ Ω·cm) or semiconductive (e.g., having a volume resistivity of from 10⁷ Ω·cm to 10¹³ Ω·cm)). The conductive material may be added depending on the intended use, for example, in order to impart conductivity.

Examples of conductors include carbon blacks (e.g., acidic carbon blacks with a pH of 5.0 or less); metals (e.g., aluminum and nickel); metal oxides (e.g., yttrium oxide and tin oxide); and conically conductive materials (e.g., potassium titanate and LiCl). These conductive materials may be used alone or in combination of two or more.

### Method for Preparing Rubber-Particle-Dispersed Polyimide Resin Solution

Examples of methods for preparing the rubber-particle-dispersed polyimide resin solution according to the exemplary embodiment include the following methods (i) and (ii).

(i) A method including preparing a soluble polyimide or polyimide precursor solution and then mixing and dispersing rubber particles therein

(ii) A method including preparing a dispersion of rubber particles and synthesizing a soluble polyimide or polyimide precursor in the dispersion

(i) The method including mixing and dispersing rubber particles in a soluble polyimide or polyimide precursor solution.

A soluble polyimide or polyimide precursor is first dissolved in some or all of the solvent for the rubber-particle-dispersed polyimide resin solution according to the exemplary embodiment. If a synthesized soluble polyimide or polyimide precursor is used, a soluble polyimide or polyimide precursor may be prepared in advance by polymerization in some or all of the solvent for the rubber-particle-dispersed polyimide resin solution according to the exemplary embodiment. If a soluble polyimide or polyimide precursor is synthesized in a different solvent, a powder of the synthesized soluble polyimide or polyimide precursor is recovered and then dissolved in some or all of the solvent for the rubber-particle-dispersed polyimide resin solution according to the exemplary embodiment.

Rubber particles are then mixed and dispersed in the resulting soluble polyimide or polyimide precursor solution. Rubber particles available in powder form may be directly used. Rubber particles obtained as an aqueous dispersion may be directly used if water is used as the poor solvent; if an organic solvent is used as the poor solvent, a powder of rubber particles is recovered and used.

If a powder of rubber particles is used, the powder may be directly added to and mixed and dispersed in the soluble polyimide or polyimide precursor solution. Alternatively, a powder of rubber particles alone may be mixed and dispersed in some or all of the solvent for the rubber-particle-dispersed polyimide resin solution according to the exemplary embodiment and may then be mixed with the soluble polyimide or polyimide precursor solution.

(ii) The method including preparing a dispersion of rubber particles and preparing a soluble polyimide or polyimide precursor in the dispersion.

If an organic solvent is used as the poor solvent to prepare the rubber-particle-dispersed polyimide resin solution according to the exemplary embodiment, a dispersion of rubber particles in the poor solvent for the rubber particles and a solvent in which a soluble polyimide or polyimide precursor is soluble is first provided. Then, if a polyimide precursor is used, a tetracarboxylic dianhydride and a diamine compound are polymerized in the dispersion to produce a resin (polyimide precursor). The polyimide precursor is produced by polymerization in a temperature range in which the rubber particles are unlikely to deform, aggregate, coalesce, or decompose. If a soluble polyimide is used as the resin, polymerization is followed by imidization. If imidization is performed by heating, imidization is performed in a temperature range in which the rubber particles do not deform, aggregate, coalesce, or decompose. An imidization catalyst as mentioned above may optionally be added to perform imidization at low temperatures. Thus, a soluble polyimide or polyimide precursor solution having rubber particles dispersed therein can be obtained.

If water is used as the poor solvent to prepare the rubber-particle-dispersed polyimide resin solution according to the exemplary embodiment, an aqueous dispersion of rubber particles is first provided. Other organic solvents miscible with water may optionally be added. A tetracarboxylic dianhydride and a diamine compound are then polymerized in the dispersion in the presence of an organic amine compound to produce a polyimide precursor and thus obtain a rubber-particle-dispersed polyimide resin solution. The polyimide precursor is produced by polymerization in a temperature range in which the rubber particles do not deform, aggregate, coalesce, or decompose.

The rubber-particle-dispersed polyimide resin solution may also contain inorganic particles. The inorganic particles may be added depending on the intended use in order to improve mechanical strength. Examples of inorganic particles include particulate materials such as silica powder, alumina powder, barium sulfate powder, titanium oxide powder, mica, and talc.

To obtain a rubber-particle-dispersed polyimide sheet with reduced susceptibility to surface scratches from the rubber-particle-dispersed polyimide resin solution according to the exemplary embodiment, the resin may be a polyimide precursor, the poor solvent may be water, and the imidization catalyst may be an organic amine compound. From the same viewpoint, the amount of the water may be 50% by mass or more based on the total mass of the solvent. From the same viewpoint, the solvent may further contain an aprotic polar solvent. If an aprotic polar solvent is used, the amount of the aprotic polar solvent may be 50% by mass or less based on the solid content of the rubber-particle-dispersed polyimide resin solution. If an aprotic polar solvent is used, the solvent may be a mixture of water with an aprotic polar solvent.

### Method for Preparing Rubber-Particle-Dispersed Polyimide Sheet

A rubber-particle-dispersed polyimide sheet according to the exemplary embodiment is obtained by applying the rubber-particle-dispersed polyimide resin solution according to the exemplary embodiment to form a coating and then heating the coating.

In the exemplary embodiment, “sheet” is meant to include not only film-like products generally called “sheet” (e.g., those with thicknesses of 100 μm or more), but also film-like products generally called “film” (e.g., those with thicknesses of 100 μm or less).

Specifically, a method for preparing the rubber-particle-dispersed polyimide sheet according to the exemplary embodiment includes, for example, a step of applying the rubber-particle-dispersed polyimide resin solution according to the exemplary embodiment to form a coating (hereinafter referred to as “coating formation step”) and a step of heating the coating at 300° C. or lower to form a rubber-particle-dispersed polyimide sheet (hereinafter referred to as “heating step”).

### Coating Formation Step

The rubber-particle-dispersed polyimide resin solution is first provided. The rubber-particle-dispersed polyimide resin solution is then applied to a substrate to form a coating.

Examples of substrates include resin substrates, glass substrates, ceramic substrates, metal substrates, and composite material substrates composed of these materials. These substrates may be subjected to release treatment to form a release layer.

Examples of techniques for applying the rubber-particle-dispersed polyimide resin solution to the substrate include various techniques such as, but not limited to, spray coating techniques, rotational coating techniques, roller coating techniques, bar coating techniques, slit die coating techniques, and inkjet coating techniques.

Various substrates may be used depending on the intended use. Examples of substrates include various substrates for liquid crystal devices, semiconductor substrates having integrated circuits formed thereon, wiring substrates having wiring lines formed thereon, printed substrates having electronic components and wiring lines disposed thereon, and substrates for electric wire coatings.

### Heating Step

The coating obtained in the coating formation step is then subjected to heating treatment. A dry film is formed by the heating treatment. If a polyimide precursor is used as the resin, imidization is completed in this step.

Although the heating temperature varies depending on the structure of the polyimide precursor, the solvent used, the type of rubber particle, and the presence or absence of an imidization catalyst, the heating temperature is lower than the decomposition temperature of the rubber particles, i.e., 300° C. or lower. For example, the heating temperature is preferably from 150° C. to 300° C., more preferably from 180° C. to 250° C. Examples of heating processes include those in which the temperature is increased stepwise and those in which the temperature is increased without changing the heating rate. The heating time may be set depending on the heating temperature.

The heating step may be performed in multiple steps. For example, after a dry film is formed and then stripped from the substrate, the self-supporting film may be subjected to further heating treatment. If the self-supporting film is subjected to further heating treatment, the film may be heated with its edge fixed (e.g., fixed with a metal frame or other member) to prevent film deformation.

A rubber-particle-dispersed polyimide sheet is formed by the foregoing process. The rubber-particle-dispersed polyimide sheet may be subjected to post-treatment depending on the intended use.

### Rubber-Particle-Dispersed Polyimide Sheet

In a rubber-particle-dispersed polyimide sheet according to the exemplary embodiment obtained from the rubber-particle-dispersed polyimide resin solution according to the exemplary embodiment, the rubber particles exhibit, for example, reduced deformation, aggregation, and coalescence and are nearly uniformly dispersed.

In the exemplary embodiment, the “aggregation” of the rubber particles refers to a state in which two or more rubber particles are in contact with each other and an interface is observed between the rubber particles in contact with each other. The “coalescence” of the rubber particles refers to a state in which two or more rubber particles are in contact and coalesced with each other and no interface is observed between the rubber particles in contact with each other.

When a cross-section of the rubber-particle-dispersed polyimide sheet according to the exemplary embodiment is observed under a scanning electron microscope, the amount of the rubber particles which are aggregated or coalesced may be 10% or less of the total number of rubber particles observed in a predetermined field of view.

If the percentage of the rubber particles which are aggregated or coalesced falls within the above range, the rubber-particle-dispersed polyimide sheet may exhibit reduced susceptibility to surface scratches and improved bending resistance.

To achieve reduced susceptibility to surface scratches, it is preferred that, of the rubber particles present in the rubber-particle-dispersed polyimide sheet according to the exemplary embodiment, the amount of the rubber particles having a ratio of the maximum size (major axis) to the minimum size (minor axis) (maximum size/minimum size) of 1.5 or more be 20% or less of the total number of rubber particles observed under a scanning electron microscope. From the same viewpoint, it is more preferred that the amount of such rubber particles be 10% or less of the total number of rubber particles observed under a scanning electron microscope.

It is also preferred that, of the rubber particles present in the rubber-particle-dispersed polyimide sheet according to the exemplary embodiment, the amount of the rubber particles having a deviation of 50% or more from the volume average particle size of the rubber particles used to produce the rubber-particle-dispersed polyimide sheet be 30% or less of the total number of rubber particles observed under a scanning electron microscope. Within this range, the rubber-particle-dispersed polyimide sheet may exhibit reduced susceptibility to surface scratches. It is more preferred that the amount of such rubber particles be 25% or less of the total number of rubber particles observed under a scanning electron microscope.

As used herein, the number percentage of rubber particles having a deviation of 50% or more from the volume average particle size of the rubber particles refers to the percentage of the total number of rubber particles having particle sizes that are 50% or more smaller than the volume average particle size of the rubber particles used to produce the rubber-particle-dispersed polyimide sheet and rubber particles having particle sizes that are 50% or more larger than the volume average particle size of the rubber particles used to produce the rubber-particle-dispersed polyimide sheet. That is, the amount of the rubber particles that have particle sizes with a deviation in a range from more than −50% to less than +50% from the volume average particle size of the rubber particles used to produce the rubber-particle-dispersed polyimide sheet may be 70% or more of the rubber particles present in the rubber-particle-dispersed polyimide sheet according to the exemplary embodiment.

The thickness of the rubber-particle-dispersed polyimide sheet according to the exemplary embodiment may be, for example, but not limited to, from 10 μm to 1,000 μm.

### Applications of Rubber-Particle-Dispersed Polyimide Sheet

The rubber-particle-dispersed polyimide sheet may be used in any application. Examples of applications include endless belts for electrophotographic apparatuses, such as transfer and transport belts, intermediate transfer belts, photoreceptor belts, and fixing belts for copiers and laser beam printers; electrical insulation sheets used for covering bus bars in converters and inverters; and high-heat-resistance, high-adhesion adhesive layers used in three-dimensional forms by folding. Other applications include insulating layers for electronic circuits, interlayer insulating materials for multilayer circuit boards, surface protective layers for semiconductor devices, insulating coatings for products such as electric wires, motors, and heaters, flexible printed circuit (FPC) boards, solar cell substrates, adhesive tapes, metal laminates such as copper clad laminates, and adhesive sheets.

### EXAMPLES

Examples will hereinafter be described, although these examples are not intended to limit the present disclosure in any way. In the following description, all parts and percentages are by mass unless otherwise specified.

### Evaluation of Rubber-Particle-Dispersed Polyimide Resin Solutions

### Viscosity Change During Storage

The viscosity of rubber-particle-dispersed polyimide resin solutions immediately after preparation is measured, which is referred to as initial viscosity. The solutions are then kept in a constant-temperature bath at 30° C. for 2 months, and the viscosity after storage is measured. The viscosity change (%) is calculated by the following equation:

Viscosity change (%)=|(viscosity after storage)−(initial viscosity)|/(initial viscosity)×100

where ∥ represents an absolute value.

### Rating Scale

A+: a viscosity change of less than 5%

A: a viscosity change of from 5% to less than 10%

B: a viscosity change of from 10% to less than 30%

C: a viscosity change of 30% or more

### Evaluation of Rubber-Particle-Dispersed Polyimide Sheets

1) Rubber-particle-dispersed polyimide sheets formed from rubber-particle-dispersed polyimide solutions immediately after preparation and 2) rubber-particle-dispersed polyimide sheets formed from rubber-particle-dispersed polyimide resin solutions after storage in the manner described above are each observed in a 20 μm square cross-section under a scanning electron microscope at a magnification of 30,000 times and are evaluated as follows.

### Aggregation and Coalescence of Particles

The percentage of the number of aggregated or coalesced particles relative to the total number of rubber particles observed in the sheets 1) and 2) is calculated.

### Particle Shape

The percentage of the number of rubber particles having a ratio of the maximum size (major axis) to the minimum size (minor axis) of 1.5 or more relative to the total number of rubber particles observed in the sheets 1) is calculated.

### Particle Size Distribution

The particle size of each rubber particle observed in the sheets 1) is measured, and the volume average particle size is calculated. The percentage of the total number of rubber particles having particle sizes with a deviation of ±50% or more from the volume average particle size (particle sizes that are 50% or more larger than the volume average particle size and particle sizes that are 50% or more smaller than the volume average particle size) relative to the total number of rubber particles observed is calculated.

### Bending Resistance of Rubber-Particle-Dispersed Polyimide Sheets

The sheets 1) and 2) are cut to a 5 cm square and are folded in half twice such that the surface that has been in contact with the substrate during film formation faces outward to obtain 2.5 cm square test pieces. These folded test pieces are kept for one week with a load of 2 kg placed on the outward-facing surface thereof (the surface that has been in contact with the substrate during film formation). Thereafter, the load is removed, and the folded portion is visually observed and is rated on the following scale: Rating Scale

A+: There is no crease or damage to the film.

A: There is a crease that disappears within one hour. There is no damage to the film.

B: There is a crease that does not disappear within one hour. There is no damage to the film.

C: There is a film crack in part of the folded portion.

C−: The film is cracked along the folded portion.

### Durability of Rubber-Particle-Dispersed Polyimide Sheets

A rubber-particle-dispersed polyimide sheet (A) with a cylindrical substrate is provided. The rubber-particle-dispersed polyimide sheet A is formed on the outer circumferential surface of a cylindrical substrate, described later. A cylindrical substrate (B) is also provided. The cylindrical substrate B is formed of the same material as the above cylindrical substrate, with 800-grit sandpaper attached to the entire outer circumferential surface thereof. The surface of the rubber-particle-dispersed polyimide sheet A is brought into contact with the surface of the 800-grit sandpaper on the cylindrical substrate B. As the rubber-particle-dispersed polyimide sheet A is rotated at 100 rpm (sheet moving speed=about 157 mm/sec), the cylindrical substrate B is rotated together (see the FIGURE, where the reference character 1 denotes a rubber-particle-dispersed polyimide sheet, the reference character 2 denotes sandpaper, the reference characters 1A and 2B denote cylindrical substrates, the reference character A denotes a rubber-particle-dispersed polyimide sheet with a cylindrical substrate, and the reference character B denotes a cylindrical substrate having sandpaper attached thereto). The total time that elapses until scratches occur on the rubber-particle-dispersed polyimide sheet A is rated as follows:

### Rating Scale

A+: 20 hours or more

A: from 15 hours to less than 20 hours

B: from 5 hours to less than 15 hours

C: from 1 hour to less than 5 hours

C−: less than 1 hour

Production of Rubber-Particle-Dispersed Polyimide Sheets with Cylindrical Substrates

A silicone release agent (manufactured by Shin-Etsu Chemical Co., Ltd., trade name: KS-700) is applied to and dried on the outer circumferential surfaces of stainless steel cylindrical substrates (cylindrical molds) with an outer diameter of 30 mm and a length of 450 mm (release agent treatment).

The rubber-particle-dispersed polyimide resin solutions of Comparative Examples 2 and 3 and the Examples are applied to the outer circumferential surfaces of the cylindrical molds subjected to release agent treatment from one end thereof to form coatings on the outer circumferential surfaces of the cylindrical molds while the cylindrical molds are rotated at a speed of 20 rpm in the circumferential direction. Specifically, each rubber-particle-dispersed polyimide resin solution is dispensed from a dispenser with an orifice diameter of 1.0 mm while the dispenser unit is moved in the axial direction of the cylindrical mold. The rubber-particle-dispersed polyimide resin solution is applied in a spiral pattern to the cylindrical mold while a metal blade disposed over the cylindrical mold is pressed against the coating at a predetermined pressure so that the coating becomes nearly uniform. After application, the blade is removed, and the cylindrical mold is rotated for 2 minutes to perform leveling.

Thereafter, the coating on the outer circumferential surface of the cylindrical mold is dried by blowing air in an atmosphere at 80° C. in a drying oven for one hour while rotating the cylindrical mold at 10 rpm. The coating is then heated from 80° C. to the temperature shown in each example at a heating rate of 5° C./min in a clean oven and is maintained at that temperature for 30 minutes. Thus, rubber-particle-dispersed polyimide sheets with cylindrical substrates are obtained. The rubber-particle-dispersed polyimide sheets have a thickness of 500 μm.

Similar sheets are also produced from solutions stored in a constant-temperature bath at 30° C. for 2 months, as described above.

### Production of Cylindrical Rubber-Particle-Dispersed

### Polyimide Sheet for Comparative Example 1

After 7 parts by mass of Polyimide Precursor PAA-1 and 3 parts by mass of Rubber Particles-1S are roll-kneaded at a set temperature of 180° C. for 5 minutes, the mixture is extruded through a single-screw extruder into a cylindrical shape on a stainless steel cylindrical substrate (cylindrical mold) with an outer diameter of 30 mm and a length of 450 mm to obtain a rubber-particle-dispersed polyimide sheet with a cylindrical substrate. The rubber-particle-dispersed polyimide sheet has a thickness of 500 μm.

### Preparation of Polyimide Precursors

### Synthesis Example 1

### Synthesis of Polyimide Precursor PAA-1

To 144.81 parts by mass of N-methylpyrrolidone is added 15.02 parts by mass of 4,4′-diaminodiphenyl ether (molecular weight=200.24), and it is dispersed with stirring at 50° C. for 10 minutes. Then, 21.18 parts by mass of 3,3′,4,4′-biphenyltetracarboxylic dianhydride (molecular weight=294.22) is added and is dissolved and reacted with stirring at a reaction temperature of 50° C. for 15 hours to obtain a polyimide precursor solution with a solid concentration of 20% by mass.

Of the foregoing conditions, the amount of tetracarboxylic dianhydride added and the amount of diamine added are calculated so that the molar ratio of all tetracarboxylic dianhydride to all diamine is 0.96:1. The amount of N-methylpyrrolidone added is calculated so that the resulting polyimide precursor solution has a solid concentration of 20% by mass.

The resulting polyimide precursor solution is then added dropwise to 3,000 parts by mass of stirred acetone to precipitate a polyimide precursor. A solid obtained by filtration is added to 500 parts by mass of acetone and is washed with stirring again. Thereafter, a solid obtained by filtration is dried in a vacuum at 30° C. to obtain Polyimide Precursor PAA-1.

### Synthesis Example 2

### Synthesis of Polyimide Precursor PAA-2

Polyimide Precursor PAA-2 is prepared as in Synthesis Example 1 except that, in Synthesis Example 1, the amount of N-methylpyrrolidone is changed to 122.89 parts by mass, and 21.18 parts by mass of 3,3′,4,4′-biphenyltetracarboxylic dianhydride (molecular weight=294.22) is replaced with 15.70 parts by mass of pyromellitic dianhydride (molecular weight=218.12).

### Synthesis Example 3

### Synthesis of Polyimide Precursor PAA-3

Polyimide Precursor PAA-3 is prepared as in Synthesis Example 1 except that, in Synthesis Example 1, the amount of N-methylpyrrolidone is changed to 118.06 parts by mass, and 15.02 parts by mass of 4,4′-diaminodiphenyl ether (molecular weight=200.24) is replaced with 8.11 parts by mass of p-phenylenediamine (molecular weight=108.14).

### Synthesis Example 4

### Synthesis of Polyimide Precursor PAA-4

Polyimide Precursor PAA-4 is prepared as in Synthesis Example 1 except that, in Synthesis Example 1, the amount of N-methylpyrrolidone is changed to 119.94 parts by mass, and 15.02 parts by mass of 4,4′-diaminodiphenyl ether (molecular weight=200.24) is replaced with 7.30 parts by mass of p-phenylenediamine (molecular weight=108.14) and 1.50 parts by mass of 4,4′-diaminodiphenyl ether (molecular weight=200.24).

### Synthesis Example 5

### Synthesis of Soluble Polyimide PI-1

To 1,000 parts by mass of stirred acetone, 100 parts by mass of the solvent-soluble polyimide varnish SPIXAREA HR005 (25% by mass NMP solution) manufactured by Somar Corporation is added dropwise to precipitate a polyimide. A solid obtained by filtration is added to 500 parts by mass of acetone and is washed with stirring again. Thereafter, a solid obtained by filtration is dried in a vacuum at 30° C. to obtain Soluble Polyimide PI-1.

### Preparation of Rubber Particles

### Synthesis Example 6

Preparation of Powdery Rubber Particles-1S from Rubber Particles-1

Powdery Rubber Particles-1S, which are a powder of Rubber Particles-1 (volume average particle size=0.2 μm), are recovered from 100 parts by mass on a solid basis of Rubber Particles-1 by freeze drying.

### Synthesis Examples 7 to 12

### Preparation of Powdery Rubber Particles-2S to -7S

Powdery Rubber Particles-2S to -7S are obtained as in Synthesis Example 6 except that Rubber Particles-1 are replaced with Rubber Particles-2 to -7.

### Rubber-Particle-Dispersed Polyimide Sheet Obtained by Melt Kneading

### Comparative Example 1

### Production of Rubber-Particle-Dispersed Polyimide Sheet for Comparative Example 1

After 7 parts by mass of Polyimide Precursor PAA-1 and 3 parts by mass of Rubber Particles-1S are roll-kneaded at a set temperature of 180° C. for 5 minutes, a sheet is formed. The resulting sheet is subjected to heat press forming at a set temperature of 250° C. to obtain a rubber-particle-dispersed polyimide sheet with a thickness of 500 μm for Comparative Example 1.

### Examples Using Organic Solvent as Poor Solvent

### Example A1

To 7.00 g of Polyimide Precursor PAA-1 are added 13.37 g of N,N-dimethylacetamide and 13.37 g of ethylene glycol, and they are mixed together. Thereafter, 3.00 g of Rubber Particles-1S are added and are mixed with stirring in an “AWAWTORI RENTARO” mixer (manufactured by Thinky Corporation) at 2,000 rpm for 2 minutes and then at 2,200 rpm for 2 minutes to obtain an organic-solvent-based rubber-particle-dispersed polyimide resin solution. Thereafter, the resulting solution is diluted, and the particle size distribution is measured by the method described above. The rubber particles have a volume average particle size of 0.2 μm, like Rubber Particles-1, and are well dispersed.

Of the foregoing conditions, the amount of Rubber Particles-1S added is calculated so that the amount of the rubber particles (solid) is 30% by mass based on the total solid content of the solution. The amounts of N,N-dimethylacetamide and ethylene glycol are calculated so that the amount of ethylene glycol is 50% by mass based on the total mass of the two solvents. The amount of N,N-dimethylacetamide is 150% by mass based on the solid content of the solution.

The resulting rubber-particle-dispersed polyimide resin solution is applied to a 100 mm square glass substrate with an applicator so that the thickness after baking is 500 μm. After the coating is dried by blowing air at 80° C. for 1 hour, the coating is heated from 80° C. to 250° C. at a heating rate of 5° C./min and is maintained at that temperature (i.e., the final heating temperature is 250° C.) for 30 minutes. Thereafter, the coating is cooled to room temperature (25° C.; the same applies hereinafter) and is immersed in water to obtain a rubber-particle-dispersed polyimide sheet.

### Examples A2 to A10 and A12

Rubber-particle-dispersed polyimide resin solutions and rubber-particle-dispersed polyimide sheets are produced as in Example A1 except that the ingredients used and the various proportions are changed to those shown in Table 1, and are evaluated as described above.

### Example A11

A rubber-particle-dispersed polyimide resin solution is prepared as in Example A1 except that the ingredients used and the various proportions are changed to those shown in Table 1, 13.37 g of N,N-dimethylacetamide and 13.37 g of ethylene glycol are added to 7.00 g of Polyimide Precursor PAA-1, and an imidization catalyst (acetic anhydride/pyridine (in a molar ratio of 1:1) is added and mixed in an amount of 5% by mass based on the mass of Polyimide Precursor PAA-1 immediately before application. A rubber-particle-dispersed polyimide sheet is also produced as in Example A1 except that the final heating temperature is 230° C.

### Comparative Examples 2 and 3

A rubber-particle-dispersed polyimide resin solution and a rubber-particle-dispersed polyimide sheet of Comparative Example 2 are produced as in Example A1 except that no poor solvent is used.

A resin-particle-dispersed polyimide resin solution and a resin-particle-dispersed polyimide sheet of Comparative Example 3 are produced as in Example A1 except that the rubber particles are replaced with resin particles.

### Examples Using Water as Poor Solvent

### Example B1

To 7.00 g of Polyimide Precursor PAA-3 are added 32.17 g of deionized water, 1.89 g of N,N-dimethylacetamide, and 5.23 g of N-methylmorpholine, and they are mixed together while being warmed to 50° C. Thereafter, 3.77 g on a solid basis (7.54 g on a solution basis) of Rubber Particles-5 (SB Latex 0589, solid content=50% by mass, manufactured by JSR Corporation) are added and are mixed with stirring in an “AWATORI RENTARO” mixer (manufactured by Thinky Corporation) at 2,000 rpm for 2 minutes and then at 2,200 rpm for 2 minutes to obtain an aqueous rubber-particle-dispersed polyimide resin solution (rubber-particle-dispersed polyimide precursor solution). The resulting solution is diluted with deionized water, and the particle size distribution is measured by the method described above. The rubber particles have a volume average particle size of 0.22 μm, like Rubber Particles-5, and are well dispersed.

Of the foregoing conditions, the amount of Rubber Particles-5 added is calculated so that the amount of the rubber particles (solid) is 35% by mass based on the total solid content of the solution. The amount of N,N-dimethylacetamide added is calculated so that the amount of N,N-dimethylacetamide is 5% by mass based on the total mass of water and N,N-dimethylacetamide. The amount of N,N-dimethylacetamide is 18% by mass based on the solid content of the solution. The amount of N-methylmorpholine is 150 mole percent based on the number of moles of carboxyl groups in the polyimide precursor to be produced. The amount of deionized water added is calculated so that the solution has a solid concentration of 20% by mass.

The resulting rubber-particle-dispersed polyimide resin solution is applied to a 100 mm square glass substrate with an applicator so that the thickness after baking is 500 μm. After the coating is dried by blowing air at 70° C. for 1 hour, the coating is heated from 70° C. to 230° C. at a heating rate of 5° C./min and is maintained at that temperature for 30 minutes. Thereafter, the coating is cooled to room temperature and is immersed in water to obtain a rubber-particle-dispersed polyimide sheet.

### Examples B2 to B9 and B11 to B13

Rubber-particle-dispersed polyimide resin solutions and rubber-particle-dispersed polyimide sheets are produced as in Example B1 except that the ingredients used and the various proportions are changed to those shown in Table 2, and are evaluated as described above.

### Example B10

To 13.41 g on a solid basis (25.79 g on a solution basis) of Rubber Particles-7 are added 111.69 g of deionized water, 6.53 g of N,N-dimethylacetamide, 10.81 g (0.1 moles) of p-phenylenediamine (molecular weight=108.14), and 29.42 g (0.1 moles) of 3,3′,4,4′-biphenyltetracarboxylic dianhydride (molecular weight=294.22), and they are dispersed with stirring at 25° C. for 10 minutes. Then, 30.35 g (0.3 moles) of N-methylmorpholine (organic amine compound) is slowly added and is dissolved and reacted with stirring at a reaction temperature of 60° C. for 24 hours to obtain an aqueous rubber-particle-dispersed polyimide resin solution. The resulting solution is diluted, and the particle size distribution is measured by the method described above. The rubber particles have an average particle size of 0.25 μm, like Rubber Particles-7, and are well dispersed.

Of the foregoing conditions, the amount of tetracarboxylic dianhydride added and the amount of diamine added are calculated so that the molar ratio of all tetracarboxylic dianhydride to all diamine is 1:1. The amount of Rubber Particles-7 added is calculated so that the amount of the rubber particles (solid) is 25% by mass based on the total solid content of the solution. The amount of N,N-dimethylacetamide added is calculated so that the amount of N,N-dimethylacetamide is 5% by mass based on the total mass of water and N,N-dimethylacetamide. The amount of N,N-dimethylacetamide is 12% by mass based on the solid content of the solution. The amount of N-methylmorpholine is 150 mole percent based on the number of moles of carboxyl groups in the polyimide precursor to be produced. The amount of deionized water added is calculated so that the solution has a solid concentration of 25% by mass.

The resulting rubber-particle-dispersed polyimide resin solution is applied to a 100 mm square glass substrate with an applicator so that the thickness after baking is 500 μm. After the coating is dried by blowing air at 70° C. for 1 hour, the coating is heated from 70° C. to the temperature shown in each example at a heating rate of 5° C./min and is maintained at that temperature for 30 minutes. Thereafter, the coating is cooled to room temperature and is immersed in water to obtain a rubber-particle-dispersed polyimide sheet.

TABLE 1

| | | Comp. | Comp. | | Comp. | | | |
|---|---|---|---|---|---|---|---|---|
| | | Ex. 1 | Ex. 2 | Ex. A1 | Ex. 3 | Ex. A2 | Ex. A3 | Ex. A4 |
| Resin | | PI-1 | PAA-1 | PAA-1 | PAA-1 | PAA-1 | PAA-1 | PAA-1 |
| Type of particle | | Rubber | Rubber | Rubber | PMMA-1 | Rubber | Rubber | Rubber |
| | | Particles- | Particles- | Particles- | | Particles- | Particles- | Particles- |
| | | 1S | 1S | 1S | | 2S | 2S | 3S |
| Volume average particle size (D50v) | μm | 0.2 | 0.2 | 0.2 | 0.2 | 0.1 | 0.1 | 0.15 |
| Solid content of solution | mass % | 100 | 25 | 25 | 25 | 25 | 25 | 25 |
| Mass fraction of rubber particles | mass % | 30 | 30 | 30 | 30 | 3 | 5 | 10 |
| based on solid content of solution | | | | | | | | |
| Imidization catalyst | | — | — | — | — | — | — | — |
| Type of organic amine | | — | — | — | — | — | — | — |
| Solvent 1 (poor solvent for rubber | | — | — | EG | EG | EG | EG | Triglyme |
| particles) | | | | | | | | |
| Solvent 2 (aprotic polar solvent) | | — | DMAc | DMAc | DMAc | DMAc | DMAc | DMAc |
| Mass fraction of Solvent 1 based on | mass % | — | 0 | 50 | 50 | 50 | 50 | 35 |
| total mass of all solvents | | | | | | | | |
| Mass fraction of Solvent 2 based on | mass % | — | 300 | 150 | 150 | 150 | 150 | 195 |
| solid content of solution | | | | | | | | |
| Method for preparing coating solution | | (Melt | Mixing | Mixing | Mixing | Mixing | Mixing | Mixing |
| | | kneading) | and | and | and | and | and | and |
| | | | dispersion | dispersion | dispersion | dispersion | dispersion | dispersion |
| Viscosity change during storage | | — | C | A | A | A+ | A+ | A |
| Percentage of aggregated or coalesced | number % | 17 | 24 | 6 | 7 | 6 | 7 | 6 |
| rubber particles | | | | | | | | |
| Percentage of aggregated or coalesced | number % | — | 41 | 7 | 10 | 8 | 8 | 7 |
| rubber particles (after storage of | | | | | | | | |
| solution) | | | | | | | | |
| Percentage of rubber particles having | number % | 27 | 24 | 12 | 11 | 13 | 15 | 13 |
| major-to-minor axis ratio of 1.5 or | | | | | | | | |
| more | | | | | | | | |
| Percentage of rubber particles having | number % | 43 | 46 | 15 | 13 | 15 | 17 | 15 |
| deviation of ±50% or more from | | | | | | | | |
| average particle size | | | | | | | | |
| Bending resistance | | C | C | A+ | C− | A | A | A |
| Bending resistance (after storage of | | — | C− | A | C− | A | A | A |
| solution) | | | | | | | | |
| Durability | | C | C | A+ | C− | A | A+ | A+ |
| Durability (after storage of solution) | | — | C− | A | C− | A | A | A |

| | | Ex. A5 | Ex. A6 | Ex. A7 | Ex. A8 | Ex. A9 | Ex. A10 | Ex. A11 | Ex. A12 |
|---|---|---|---|---|---|---|---|---|---|
| Resin | | PAA-2 | PAA-2 | PAA-3 | PAA-3 | PAA-2 | PAA-3 | PAA-1 | PI-1 |
| Type of particle | | Rubber | Rubber | Rubber | Rubber | Rubber | Rubber | Rubber | Rubber |
| | | Particles- | Particles- | Particles- | Particles- | Particles- | Particles- | Particles- | Particles- |
| | | 6S | 6S | 5S | 5S | 4S | 2S | 4S | 1S |
| Volume average particle size (D50v) | μm | 0.16 | 0.16 | 0.22 | 0.22 | 0.3 | 0.1 | 0.22 | 0.2 |
| Solid content of solution | mass % | 30 | 30 | 30 | 30 | 20 | 25 | 25 | 20 |
| Mass fraction of rubber particles | mass % | 40 | 40 | 45 | 55 | 25 | 30 | 30 | 30 |
| based on solid content of solution | | | | | | | | | |
| Imidization catalyst | | — | — | — | — | — | — | Catalyst-1 | — |
| Type of organic amine | | — | — | — | — | — | — | — | — |
| Solvent 1 (poor solvent for rubber | | Triglyme | Triglyme | DEGME | DEGME | EG | EG | EG | Triglyme |
| particles) | | | | | | | | | |
| Solvent 2 (aprotic polar solvent) | | TMU | TMU | DMAc | DMAc | DMAc | DMAc | DMAc | DMAc |
| Mass fraction of Solvent 1 based on | mass % | 60 | 65 | 40 | 40 | 35 | 25 | 50 | 50 |
| total mass of all solvents | | | | | | | | | |
| Mass fraction of Solvent 2 based on | mass % | 93 | 82 | 140 | 140 | 260 | 225 | 150 | 200 |
| solid content of solution | | | | | | | | | |
| Method for preparing coating solution | | Mixing | Mixing | Mixing | Mixing | Mixing | Mixing | Mixing | Mixing |
| | | and | and | and | and | and | and | and | and |
| | | dispersion | dispersion | dispersion | dispersion | dispersion | dispersion | dispersion | dispersion |
| Viscosity change during storage | | A+ | A | A | A | A | A | A+ | A |
| Percentage of aggregated or coalesced | number % | 6 | 5 | 7 | 9 | 9 | 8 | 4 | 6 |
| rubber particles | | | | | | | | | |
| Percentage of aggregated or coalesced | number % | 8 | 14 | 9 | 10 | 10 | 9 | 6 | 7 |
| rubber particles (after storage of | | | | | | | | | |
| solution) | | | | | | | | | |
| Percentage of rubber particles having | number % | 13 | 12 | 14 | 17 | 18 | 16 | 9 | 12 |
| major-to-minor axis ratio of 1.5 or | | | | | | | | | |
| more | | | | | | | | | |
| Percentage of rubber particles having | number % | 16 | 14 | 18 | 22 | 21 | 20 | 8 | 15 |
| deviation of ±50% or more from | | | | | | | | | |
| average particle size | | | | | | | | | |
| Bending resistance | | A+ | A+ | A+ | A+ | A | A | A+ | A+ |
| Bending resistance (after storage of | | A | A | A | A | A | A | A+ | A |
| solution) | | | | | | | | | |
| Durability | | A+ | A | A+ | A | A | A | A+ | A+ |
| Durability (after storage of solution) | | A | A | A | A | A | A | A | A |

TABLE 2

| | | Ex. B1 | Ex. B2 | Ex. B3 | Ex. B4 | Ex. B5 | Ex. B6 | Ex. B7 |
|---|---|---|---|---|---|---|---|---|
| Resin | | PAA-3 | PAA-3 | PAA-1 | PAA-3 | PAA-3 | PAA-2 | PAA-3 |
| Type of particle | | Rubber | Rubber | Rubber | Rubber | Rubber | Rubber | Rubber |
| | | Particles- | Particles- | Particles- | Particles- | Particles- | Particles- | Particles- |
| | | 5 | 3 | 1 | 2 | 5 | 7 | 3 |
| Volume average particle size (D50v) | μm | 0.22 | 0.15 | 0.2 | 0.1 | 0.22 | 0.25 | 0.15 |
| Solid content of solution | mass % | 20 | 20 | 20 | 20 | 20 | 25 | 20 |
| Mass fraction of rubber particles | mass % | 35 | 40 | 40 | 30 | 35 | 35 | 25 |
| based on solid content of solution | | | | | | | | |
| Imidization catalyst | | — | — | — | — | — | — | — |
| Type of organic amine | | MMO | DMAEt | DMIz | DMAEt | DMAEt | MMO | DMAEt |
| Solvent 1 (poor solvent for rubber | | Water | Water | Water | Water | Water | Water | Water |
| particles) | | | | | | | | |
| Solvent 2 (aprotic polar solvent) | | DMAc | DMAc | DMAc | — | DMAc | DMAc | NMP |
| Mass fraction of Solvent 1 based on | mass % | 95 | 90 | 83 | 100 | 45 | 95 | 95 |
| total mass of all solvents | | | | | | | | |
| Mass fraction of Solvent 2 based on | mass % | 18 | 36 | 62 | 0 | 196 | 13 | 18 |
| solid content of solution | | | | | | | | |
| Method for preparing coating solution | | Mixing | Mixing | Mixing | Mixing | Mixing | Mixing | Mixing |
| | | and | and | and | and | and | and | and |
| | | dispersion | dispersion | dispersion | dispersion | dispersion | dispersion | dispersion |
| Viscosity change during storage | | A+ | A+ | A | A+ | A | A+ | A+ |
| Percentage of aggregated or coalesced | number % | 4 | 5 | 8 | 3 | 9 | 4 | 6 |
| rubber particles | | | | | | | | |
| Percentage of aggregated or coalesced | number % | 5 | 8 | 9 | 5 | 5 | 5 | 7 |
| rubber particles (after storage of | | | | | | | | |
| solution) | | | | | | | | |
| Percentage of rubber particles having | number % | 6 | 9 | 14 | 5 | 17 | 6 | 8 |
| major-to-minor axis ratio of 1.5 or | | | | | | | | |
| more | | | | | | | | |
| Percentage of rubber particles having | number % | 7 | 10 | 12 | 6 | 19 | 7 | 10 |
| deviation of ±50% or more from | | | | | | | | |
| average particle size | | | | | | | | |
| Bending resistance | | A+ | A+ | A+ | A+ | A+ | A+ | A+ |
| Bending resistance (after storage of | | A+ | A+ | A+ | A | A+ | A+ | A+ |
| solution) | | | | | | | | |
| Durability | | A+ | A+ | A+ | A+ | A+ | A+ | A+ |
| Durability (after storage of solution) | | A+ | A+ | A | A | A | A+ | A+ |

| | | Ex. B8 | Ex. B9 | Ex. B10 | Ex. B11 | Ex. B12 | Ex. B13 |
|---|---|---|---|---|---|---|---|
| Resin | | PAA-2 | PAA-4 | PAA-3 | PAA-3 | PAA-3 | PAA-3 |
| Type of particle | | Rubber | Rubber | Rubber | Rubber | Rubber | Rubber |
| | | Particles- | Particles- | Particles- | Particles- | Particles- | Particles- |
| | | 4 | 1 | 7 | 5 | 3 | 3 |
| Volume average particle size (D50v) | μm | 0.3 | 0.2 | 0.25 | 0.22 | 0.15 | 0.15 |
| Solid content of solution | mass % | 20 | 20 | 25 | 20 | 20 | 20 |
| Mass fraction of rubber particles | mass % | 30 | 35 | 25 | 35 | 25 | 25 |
| based on solid content of solution | | | | | | | |
| Imidization catalyst | | — | — | — | — | — | — |
| Type of organic amine | | DMIz | MMO | MMO | AEt | DMAEt | DMAEt |
| Solvent 1 (poor solvent for rubber | | Water | Water | Water | Water | Water | Water |
| particles) | | | | | | | |
| Solvent 2 (aprotic polar solvent) | | TMU | DMAc | DMAc | DMAc | NMP | NMP |
| Mass fraction of Solvent 1 based on | mass % | 90 | 95 | 95 | 95 | 95 | 95 |
| total mass of all solvents | | | | | | | |
| Mass fraction of Solvent 2 based on | mass % | 35 | 18 | 12 | 19 | 17 | 16 |
| solid content of solution | | | | | | | |
| Method for preparing coating solution | | Mixing | Mixing | Resin | Mixing | Mixing | Mixing |
| | | and | and | polymerization | and | and | and |
| | | dispersion | dispersion | in presence of | dispersion | dispersion | dispersion |
| | | | | particles | | | |
| Viscosity change during storage | | A+ | A+ | A+ | A | A+ | A |
| Percentage of aggregated or coalesced | number % | 7 | 7 | 5 | 8 | 7 | 7 |
| rubber particles | | | | | | | |
| Percentage of aggregated or coalesced | number % | 8 | 9 | 7 | 10 | 8 | 9 |
| rubber particles (after storage of | | | | | | | |
| solution) | | | | | | | |
| Percentage of rubber particles having | number % | 11 | 8 | 9 | 18 | 9 | 13 |
| major-to-minor axis ratio of 1.5 or | | | | | | | |
| more | | | | | | | |
| Percentage of rubber particles having | number % | 12 | 10 | 11 | 29 | 12 | 16 |
| deviation of ±50% or more from | | | | | | | |
| average particle size | | | | | | | |
| Bending resistance | | A+ | A+ | A+ | A | A+ | A+ |
| Bending resistance (after storage of | | A+ | A+ | A+ | A | A+ | A |
| solution) | | | | | | | |
| Durability | | A+ | A+ | A+ | A | A+ | A+ |
| Durability (after storage of solution) | | A+ | A+ | A+ | A | A+ | A |

The meanings of the abbreviations shown in Tables 1 and 2 are as follows:

Type of Resin

PAA-1: polyimide precursor of Synthesis Example 1

PAA-2: polyimide precursor of Synthesis Example 2

PAA-3: polyimide precursor of Synthesis Example 3

PAA-4: polyimide precursor of Synthesis Example 4

PI-1: soluble polyimide, SPIXAREA HR005 manufactured by Somar Corporation

Type of Particle

Rubber Particles-1: SR-102 (manufactured by Nippon A&L Inc.), solid content=48%

Rubber Particles-2: NIPOL SX1105A (manufactured by Zeon Corporation), solid content=45%

Rubber Particles-3: NIPOL LX430 (manufactured by Zeon Corporation), solid content=49%

Rubber Particles-4: NIPOL LX531B (manufactured by Zeon Corporation), solid content=66%

Rubber Particles-5: SB Latex 0589 (manufactured by JSR Corporation), solid content=50%

Rubber Particles-6: SR-104 (manufactured by Nippon A&L Inc.), solid content=48%

Rubber Particles-7: NIPOL 2507H (manufactured by Zeon Corporation), solid content=52%

PMMA-1: MP-2801 (manufactured by Soken Chemical & Engineering Co., Ltd.) powder

Imidization Catalyst

Catalyst-1: acetic anhydride/pyridine (in a molar ratio of 1:1)

Organic Amine Compound

MMO: N-methylmorpholine

DMAEt: dimethylaminoethanol

DMIz: 1,2-dimethylimidazole

AEt: aminoethanol

Solvent 1

EG: ethylene glycol

DEGME: diethylene glycol monomethyl ether

Solvent 2

DMAc: N,N-dimethylacetamide

TMU: tetramethylurea

NMP: N-methylpyrrolidone

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A rubber-particle-dispersed polyimide resin solution comprising:
at least one resin selected from the group consisting of polyimide precursors and polyimides having a solubility of 1% by mass or more in an aprotic polar solvent;
rubber particles; and
a solvent comprising a poor solvent for the rubber particles.

2. The rubber-particle-dispersed polyimide resin solution according to claim 1, further comprising an imidization catalyst.

3. The rubber-particle-dispersed polyimide resin solution according to claim 1, wherein the rubber particles have a volume average particle size in a range from 0.05 μm to 2 μm.

4. The rubber-particle-dispersed polyimide resin solution according to claim 1, wherein the amount of the rubber particles is in a range from 5% by mass to 50% by mass based on a solid content of the rubber-particle-dispersed polyimide resin solution.

5. The rubber-particle-dispersed polyimide resin solution according to claim 1, wherein the rubber particle comprises at least one rubber selected from the group consisting of styrene-butadiene-based rubber, acrylonitrile-butadiene-based rubber, and silicone-based rubber.

6. The rubber-particle-dispersed polyimide resin solution according to claim 5, wherein the rubber particle comprises at least one rubber selected from styrene-butadiene-based rubber and acrylonitrile-butadiene-based rubber.

7. The rubber-particle-dispersed polyimide resin solution according to claim 1, wherein the solvent is a mixture of an organic solvent and an aprotic polar solvent, and the organic solvent is a poor solvent for the rubber particles.

8. The rubber-particle-dispersed polyimide resin solution according to claim 7, wherein the amount of the organic solvent is in a range from 30% by mass to 60% by mass based on a total mass of the solvent.

9. The rubber-particle-dispersed polyimide resin solution according to claim 7, wherein the amount of the aprotic polar solvent is in a range from 90% by mass to 250% by mass based on a solid content of the rubber-particle-dispersed polyimide resin solution.

10. The rubber-particle-dispersed polyimide resin solution according to claim 7, wherein a boiling point of the organic solvent is 20° C. or more higher than a boiling point of the aprotic polar solvent.

11. The rubber-particle-dispersed polyimide resin solution according to claim 7, wherein the organic solvent is at least one selected from the group consisting of aliphatic-alcohol-based solvent, glycol-based solvent, glycol-monoether-based solvent, and glycol-diether-based solvent.

12. The rubber-particle-dispersed polyimide resin solution according to claim 2, wherein the poor solvent is water, and the imidization catalyst is an organic amine compound.

13. The rubber-particle-dispersed polyimide resin solution according to claim 12, wherein the organic amine compound is a tertiary amine compound.

14. The rubber-particle-dispersed polyimide resin solution according to claim 12, wherein the amount of the organic amine compound is in a range from 120 mole percent to 200 mole percent based on a number of moles of carboxyl groups in the polyimide precursor.

15. The rubber-particle-dispersed polyimide resin solution according to claim 12, wherein the amount of the water is 50% by mass or more based on a total mass of the solvent.

16. The rubber-particle-dispersed polyimide resin solution according to claim 12, wherein the solvent further contains an aprotic polar solvent.

17. The rubber-particle-dispersed polyimide resin solution according to claim 16, wherein the amount of the aprotic polar solvent is 50% by mass or less based on a solid content of the rubber-particle-dispersed polyimide resin solution.

18. A rubber-particle-dispersed polyimide sheet comprising rubber particles, wherein the amount of the rubber particles which are aggregated or coalesced is 10% or less of a total number of rubber particles.

19. The rubber-particle-dispersed polyimide sheet according to claim 18, wherein the amount of the rubber particles having a ratio of a maximum size to a minimum size (maximum size/minimum size) of 1.5 or more is 20% or less of the total number of rubber particles.

20. The rubber-particle-dispersed polyimide sheet according to claim 18, wherein the amount of the rubber particles having a deviation of 50% or more from a volume average particle size is 30% or less of the total number of rubber particles.
